(19) United States
(12) Patent Application Publication
(10) Pub. No.: US 2002/0149220 A1
(43) Pub. Date: Oct. 17, 2002

(54) Vehicle, collapsible room extensions

(76) Inventor: Randell J. Wishart, Reno, NV (US)

Correspondence Address: Randell J. Wishart, 316 Calif. Ave. # 324, Reno, NV, 89509, US

(21) Appl. No.: 10/037,542

(22) Filed: Oct. 22, 2001

Related U.S. Application Data
(60) Provisional application No. 60/243,833, filed on Oct. 30, 2000.

(51) Int. Cl. B62C 1/06

(52) U.S. Cl. 296/26.15

(57) ABSTRACT

A vehicle, when equipped with the “Vehicle, collapsible room extensions” system, is provided with additional living or working space. The increased size now available allows the never before possible, addition of totally independent room(s). The room(s) panels, i.e., floor, walls and ceiling, are all substantially hinged to each other at the edges. When hinged opened, a standard looking ridged material room is created. When folded, collapsed in to each other, the panels are reduced to a very thin flat stack, facilitating compact storage for traveling. This stack is attached and transported on the exterior of the vehicle. No part of the “Vehicle, collapsible room extensions” unit is projected in to the vehicle, this allows unobstructed full use of the original vehicles inside space while traveling. Traditional slide outs, do obstruct, restrict and hamper the original vehicles usable interior space.

### FIELD OF THE INVENTION

The invention relates to a vehicle room extension or complete room(s) addition; either retro fitted to an existing vehicle or manufactured in to a new vehicle. The goal is to increase the interior useable space while parked. More particularly, the room extension consisting of solid hinged panels, attached proximate the exterior of a vehicle. The panels, when erected, are all substantially hinged with each other and form a ridged expanded room(s). When collapsed, folded flat and stored in the traveling position, the panels are held close to the exterior of the vehicle. While transporting, unlike traditional slide outs, the room extension doesn't restrict, or hamper the original vehicles usable interior space.

### BACKGROUND OF THE INVENTION

Vehicles have dimensional limits to accommodate highway regulations. The interior space is there for restricted by the width and length of the vehicles. Many variations of the traditional slide out room extension are used to try to over come this interior space limitation, however none have solved the problem as well as this new invention is capable of doing.

In order to increase the useable interior space of a vehicle the “Vehicle, collapsible room extensions” system is added to the body of a vehicle. These room(s) are retracted, folded flat and stored on the out side of the vehicle during highway travel. When the vehicle is parked, the room(s) extension are unfolded and set up, by using any number of powered or manual means. The room(s) extension is first, power hinged opened, second power hinged into the usable position and third the end walls are hinged, slid out or other wise put in to place, to seal close in the ends of the room(s). When a vehicle is set up using this “Vehicle, collapsible room extensions,” the useable interior space of the vehicles is greatly increased. The use of the expandable room(s) removes conventional size limitations that restrict all currently available room extension systems and allows the never before addition of totally separated room(s) to be added on to a vehicle. And while transporting, unlike traditional slide outs, no part of the “Vehicle, collapsible room extensions” is projected into the vehicle. This results in a non restricted, or hampered use of the original vehicles interior space.

None of the following patents have disclosed a hinging room(s) system, with the use of all solid panels; nor do they offers the advantages that are presented with in the scope of this invention. U.S. Pat. No. 2,552,691, issued in May of 1951, is a room expansion that rotates out of the main body.

U.S. Pat. No. 2,913,775, issued in Nov. of 1959, is a supplementary room structure for a house trailer.

U.S. Pat. No. 3,511,529, issued in May of 1970, is a room expansion that has a hinged floor, with a tent put on that floor.

U.S. Pat. No. 3,608,653, issued in Sept. of 1971, is a tent trailer, which has hinged down bed area off the end of the trailer.

U.S. Pat. No. 5,967,583, issued in May of 1951, is a room expansion that is a slide out room.

U.S. Pat. No. 4,222,604, issued in Sept. of 1980, is a room expansion that has independently hinging roof and floor panels, surrounded with a tent type sidewalls.

U.S. Pat. No. 4,960,299, issued in Oct. of 1990, is a room expansion that hinges out, with one end that slides along on wall-mounted tracks. The roof and floor hinge in to place with the walls.

U.S. Pat. No. 5,417,468, issued in May of 1995, that shows a hinge down deck.

U.S. Pat. No. 5,785,373, issued in July of 1998, is a room expansion that is a slide out with a latching system.

U.S. Pat. No. 5,992,920, issued in Nov. of 1999, is a flexible fabric enclosure that hinges out of the walls.

### SUMMARY OF THE INVENTION

An objective of the present invention is to provide substantial improvements in available interior space over other room(s) extension systems currently available. Another objective of the present inventions to allow the addition of completely separate room(s) if so desired.

A further objective of the present invention, unlike conventional slide out units, this system has the ability to avoid any obstruction or restricted use of the interior of the basic vehicles interior space, and when collapsed for traveling the panels are closed and stored flat on the outside of the vehicle.

Disclosed is a room(s) extensions system for a vehicle having ridged panels, substantially hinged together and collapsible. Wherein the room extension has a floor, an outside wall(s), a roof and end walls. With various hinging configurations, the floor, outside wall(s) and roof are hinged at various edges and when erected they unfold in unison. When these panels are in the opened position, they form the room(s) shape. Last the end walls are moved in to position, there by inclosing and completing the room(s). There are many obvious optional configurations alternatives for end walls i.e., sliding pocket door type walls, accordion walls, BI-fold walls, telescoping walls or just louse wall panels that are set into place. The contention is that use of any of these end walls to complete the collapsible room extension system would still be in the separate and scope of the invention.

Additionally; the end wall panels and the sidewall panel(s) can be configured so that they are substantially vertically hinged together at the ends. All walls would then hinge out in unison, forming the walls sections or shape of a room, with no floor or roof in place at this point and; next the floor and ceiling panels would be hinged in place to close in the space.

This system can be used on the sides, the ends or on the top of a vehicle.

Other objects, advantages, and novel features of the present invention will become apparent from the detailed description that follows, when considered in conjunction with the associated drawings.

### BRIEF DESCRIPTION OF THE DRAWINGS

FIGS. 1-6 Is the preferred embodiment, hinge folding rooms, with it's functions displayed.

FIGS. 6-9 Is an embodiment, hinge down rooms, with its functions displayed.

FIGS. 10-12 Is a further embodiment, hinge up rooms, with its functions displayed.

FIGS. 13-15 Is still another embodiment, hinge to top rooms, with its functions displayed.

### DESCRIPTION OF PREFERRED EMBODIMENT

While some preferred embodiments are displayed, other collapsible, ridged panel-hinging configuration embodiments are contemplated. While still within the scope of this invention, many new variations in hinging of edges, vertical or horizontal, etc., and panel-staking configurations are made possible. Their for the new possibilities for panels to be configured become to numerous to list here. Referring now to FIGS. 1-6, there is shown a preferred embodiment, of a “Vehicle, collapsible room extensions” unit. A vehicle body 1 (indicated as 1 on all FIGS. 1-15) has an attached “Vehicle, collapsible room extensions” unit 2a.

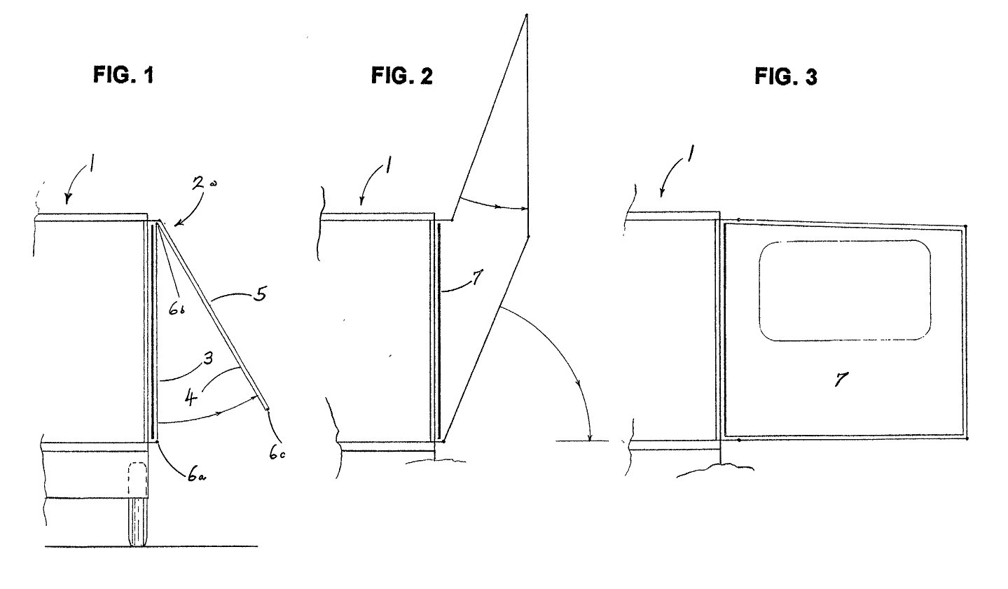

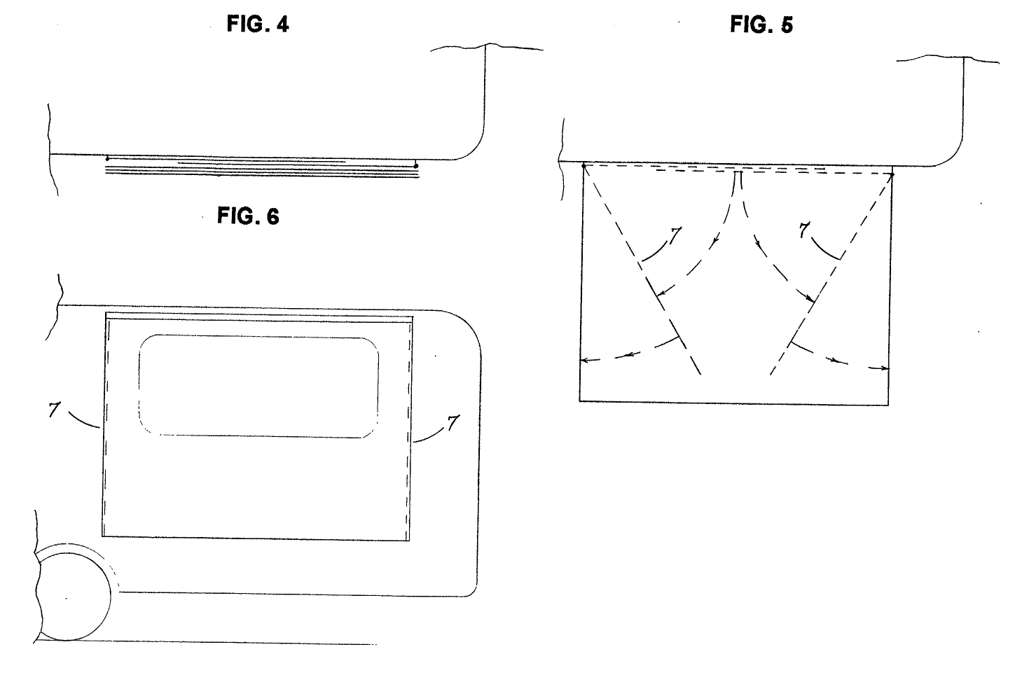

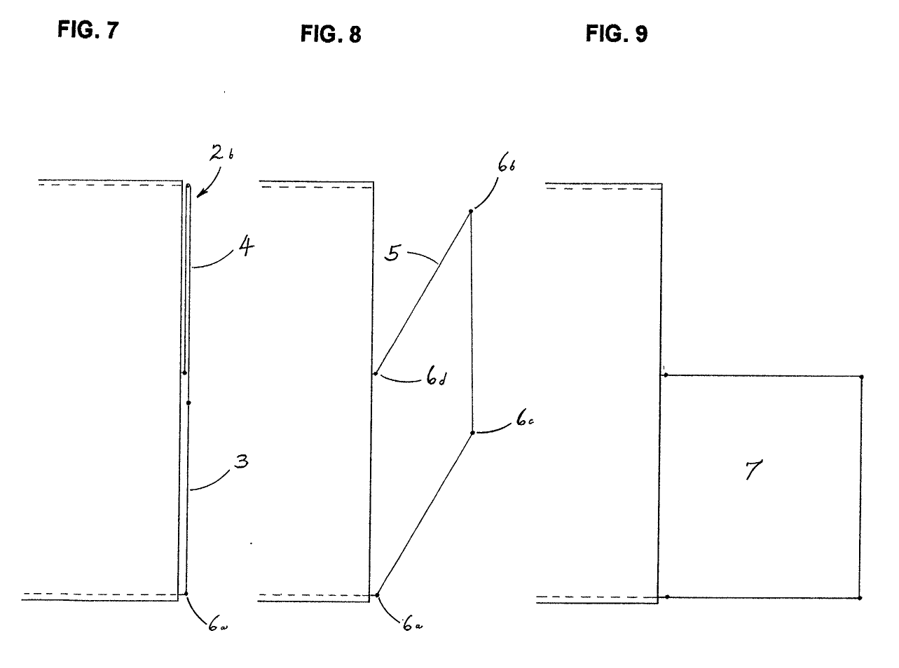

The “Vehicle, collapsible room extensions,” floor 3, sidewall 4 and ceiling 5, are all hinged at their long edges 6a 6b 6c 6d. For storage and traveling the “Vehicle, collapsible room extensions” unit 2a is folded in to it's locked position FIG. 4. When parked and ready to be used, the “Vehicle, collapsible room extensions” unit is opened by a powered means. The First Stage; to start the set up process, the side wall panel 4 and the roof panel 5 are swing away and arced upwards together, until the floor panel 3 and the side wall 4 are unfolded (like an opened Jack knife) and become stretched into straight alignment with each other. At this point the hinge 6b reverses it's self. The Second Stage; at this point the powered means is then reversed, this allows the floor panel 3, the side wall panel 4 and the roof panel 5, to hinge out and down together, and all in unison, move downward FIG. 2, to it's fully opened position FIG. 3. The Third Stage; finally the two end walls 7, are hinged out FIG. 5 and locked in to place FIG. 6. (Alternatively, the end walls 7, many be hinged on any edge and swing in or out) This finishes the set up process. The sequence is reversed to put the “Vehicle, collapsible room extensions” unit back into its storage position. Referring now to FIGS. 7-9, there is shown an embodiment, of a “Vehicle, collapsible room extensions” unit.

A vehicle body 1 (indicated as 1 on all FIGS. 1-15) has an attached “Vehicle, collapsible room extensions” unit 2b. The “Vehicle, collapsible room extensions,” floor 3, sidewall 4 and ceiling 5, are all hinged at their long edges 6a 6b 6c 6d. For storage and traveling the “Vehicle, collapsible room extensions” unit 2b is folded in to it's locked position FIG. 7. When parked and ready to be used, the “Vehicle, collapsible room extensions” unit is opened by a powered means. The First Stage; to start the set up process, the floor panel 3, the sidewall panel 4 and the roof panel 5, are swing away and arced downwards. This allows the floor panel 3, the sidewall panel 4 and the roof panel 5, to hinge out and down together, and all in unison to move downward FIG. 8, to it's fully opened position FIG. 9. The Third Stage; finally the two end walls 7, are hinged out “see” FIG. 5 and locked in to place FIG. 9. (Alternatively, the end walls 7, many be hinged on any edge and swing in or out) This finishes the set up process. The sequence is reversed to put the Hinge Folding Rooms unit back into its storage position.

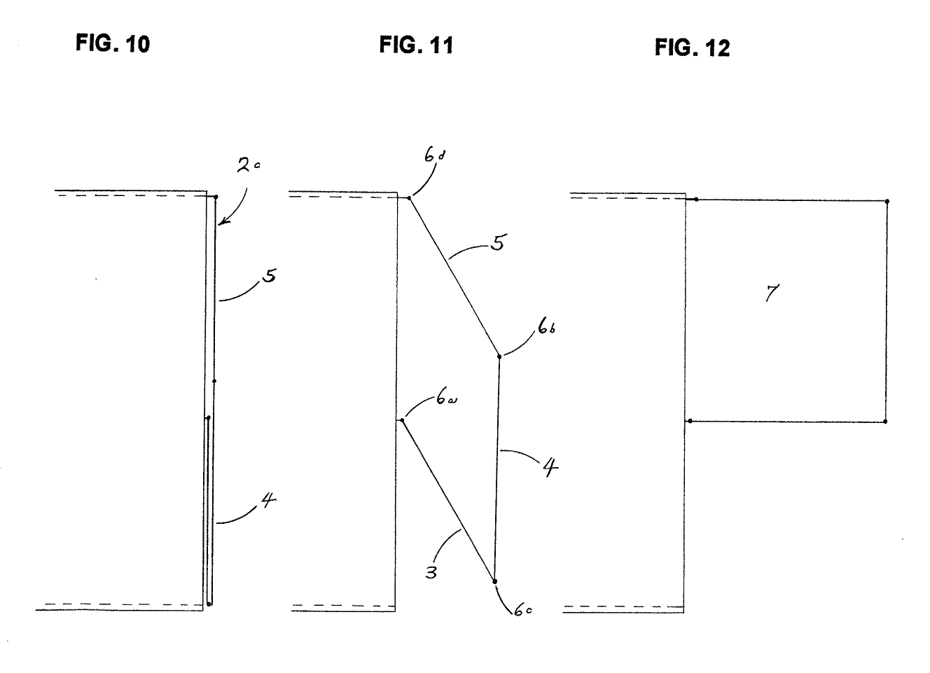

Referring now to FIGS. 10-12, there is shown an embodiment, of a “Vehicle, collapsible room extensions” unit. A vehicle body 1 (indicated as 1 on all FIGS. 1-15) has an attached “Vehicle, collapsible room extensions” unit 2c. The “Vehicle, collapsible room extensions,” floor 3, sidewall 4 and ceiling 5, are all hinged at their long edges 6a 6b 6c 6d. For storage and traveling the “Vehicle, collapsible room extensions” unit 2c is folded in to it's locked position FIG. 10. When parked and ready to be used, the “Vehicle, collapsible room extensions” unit is opened by a powered means. The First Stage; to start the set up process, the floor panel 3, the sidewall panel 4 and the roof panel 5 are swing away and arced upwards. This allows the floor panel 3, the sidewall panel 4 and the roof panel 5, to hinge out and up together, and all in unison to move upwards FIG. 11, to it's fully opened position FIG. 12. The Third Stage; finally the two end walls 7, are hinged out “see” FIG. 5 and locked in to place FIG. 9. (Alternatively, the end walls 7, many be hinged on any edge and swing in or out). This finishes the set up process. The sequence is reversed to put the Hinge Folding Rooms unit back into its storage position.

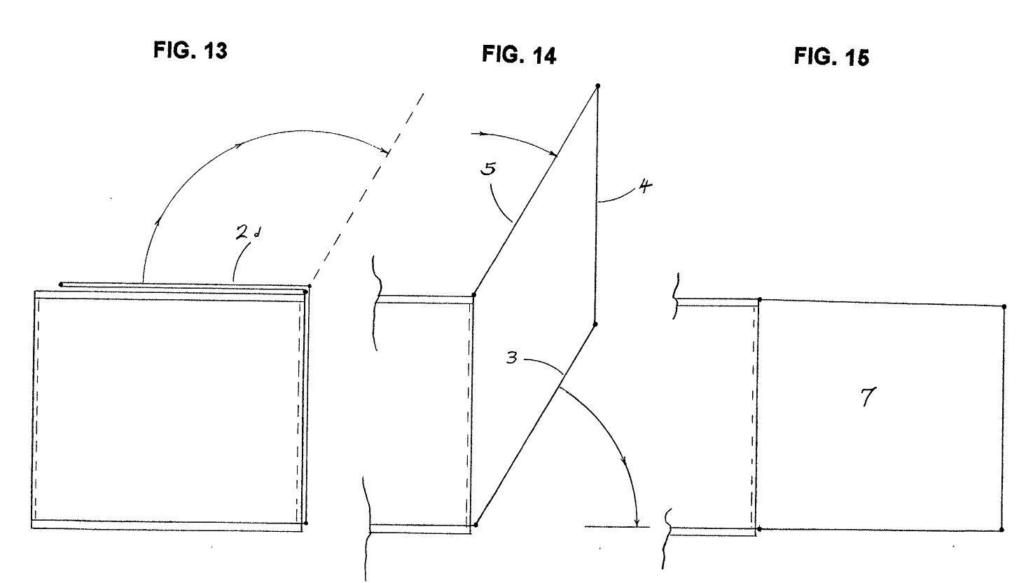

Referring now to FIGS. 13-15 there is shown an embodiment, of a “Vehicle, collapsible room extensions” unit. A vehicle body 1 (indicated as 1 on all FIGS. 1-15) has an attached “Vehicle, collapsible room extensions” unit 2d. The “Vehicle, collapsible room extensions,” floor 3, sidewall 4 and ceiling 5, are all hinged at their long edges 6a 6b 6c 6d. For storage and traveling the “Vehicle, collapsible room extensions” unit 2d is folded in to it's locked position FIG. 13. When parked and ready to be used, the “Vehicle, collapsible room extensions” unit is opened by a powered means. The First Stage; to start the set up process, the side wall panel 4 and the roof panel 5, are powered up off of the vehicles 1, roof top and arced upwards, then to a straight up point, then to over center point, then to start out and down. At this point this allows the floor panel 3, the sidewall panel 4 and the roof panel 5, to hinge out and down together, and all in unison to move downward FIG. 14, to it's fully opened position FIG. 15. The Third Stage; finally the two end walls 7, are hinged out “see” FIG. 5 and locked in to place FIG. 15. (Alternatively, the end walls 7, many be hinged on any edge and swing in or out) This finishes the set up process. The sequence is reversed to put the Hinge Folding Rooms unit back into its storage position.

What is claimed is:

1. A collapsible room extension system for a vehicle, having substantially hinged, folding, ridged panels that form a solid enclosure of usable interior space, wherein the room extension comprises:
a) all ridged panels construction, and;
b) panels substantially hinged together, and;
c) when the panels are erected they form a solid room, and,
d) when the panels are collapsed, become a flat stack.

2. The collapsible room extension system, according to claim 1, wherein said folding panels comprises:
a) a powered or manual means, that allows the erection of the hinged panels to form the room;
b) a folding Panel System, when set up, allowing greatly increased interior useable space, and;
c) when folded flat for storage and travel, requires minimal space.

3. The collapsible room extension system, according to claim 2, wherein said folding panels system:
a) can be used in new manufactured vehicles, and;
b) can also be retro fitted to existing vehicles.

4. A collapsible room extension system for a vehicle, having substantially hinged, folding, ridged panels that form usable interior space, wherein the room extension comprises:
a) a folding panel system, when set up, allowing greatly increased interior useable space, and;
b) because of the presented enlarged useable space, can now be used as a completely separated room(s).

5. The collapsible room extension system, according to claim 4, wherein said folding panels comprise:
a) a folding panel system, when folded for storage and travel, requires minimal space, and;
b) when folded, is carried on the outside of the vehicle, and;
c) in addition, no part of the room extension system is projected in to the vehicles interior space.

6. The collapsible room extension system, according to claim 5, wherein said folding panels comprise:
a) a substantially hinged together floor panel, wall panel(s) and a roof panel, and;
b) that when erected, form a separate room or a room extenuation; and
c) end walls that are moved in place, to finish closing in the space.

7. A Collapsible room extension system for a vehicle, having substantially hinged, folding, ridged panels that form usable interior space, wherein the room extension comprises:
a) a folding panel system, when set up, allowing greatly increased interior useable space, and;
b) when folded for storage and travel, requires minimal space.

8. The collapsible room extension system, according to claim 7, wherein said folding panels comprise:
a) end wall panels that are substantially hinged at the edges with the side wall panel(s) and;
b) floor and ceiling panels that hinge in place to close in the space.

9. The collapsible room extension system, according to claim 8, wherein said folding panels comprise:
a) a solid paneled room with increased floor area(s), and;
b) thereby allowing use of the newly available space as additional, separated rooms, not only the widening of the original vehicles existing area.
